(19) United States
(12) Patent Application Publication
(10) Pub. No.: US 2018/0145941 A1
(43) Pub. Date: May 24, 2018

(54) PERSONAL INFORMATION APPARATUS, SHARING SYSTEM AND SHARING SYSTEM OPERATING METHOD FOR SERVICING MAP-BASED USER GENERATED CONTENTS FOR SOCIAL NETWORK SERVICE

(71) Applicant: PAPAYA CORPORATION, Incheon (KR)

(72) Inventors: Young Jun JEON, Seongnam-si (KR); Won Ik CHOI, Incheon (KR)

(21) Appl. No.: 15/407,583

(22) Filed: Jan. 17, 2017

(30) Foreign Application Priority Data
Nov. 21, 2016 (KR) 10-2016-0155273

(51) Int. Cl. H04L 12/58; H04L 29/08; H04M 1/725; H04W 4/02

(52) U.S. Cl. CPC H04L 51/20; H04L 67/10; H04M 1/72522; H04L 67/306; H04L 67/18; H04L 51/32; H04W 4/025

(57) ABSTRACT

A personal information apparatus, sharing system and sharing system operating method for servicing map-based user generated contents for social network service. The personal information apparatus includes: a memory unit for downloading, recording, installing and operating map-based content editing application and social network service application, and downloading electronic map information about current position and recording the electronic map information in allocated space; a style editing unit for connecting with an electronic map showing coordinate information stored in the memory unit to generate user generated contents through a variety of interface; a display unit for outputting the user generated contents generated in the style editing unit; and a control unit for controlling the user generated contents, or coordinate information and property information of the user generated contents generated in the style editing unit to communicate with external server.

### CROSS-REFERENCE TO RELATED APPLICATION(S)

This application claims priority under 35 U.S.C. § 119 to Korean Patent Application No. 10-2016-0155273, filed Nov. 21, 2016, the disclosure of which is incorporated herein by reference in its entirety.

### BACKGROUND OF THE INVENTION

### 1. Field of the Invention

The present invention relates to personal information apparatus, sharing system and sharing system operating method for servicing map-based user generated contents for social network service. More particularly, the present invention relates to personal information apparatus, sharing system and sharing system operating method for the addition of user generated contents such as text, graffiti, memo, file, voice, image, picture, sketch, music, video, etc. generated by user to map-based position information while enjoying social network service with the opposing party using personal information apparatus such as a smart phone, a tablet, notebook, a portable terminal, etc. to share user generated contents with the opposing party or certain groups.

### 2. Description of Related Art

Recently, as electronics, communication, parts, manufacturing technique, etc. develops rapidly, the development of a good personal information apparatus for mobile communication is active. In addition, as the demand from each individual for a personal information apparatus for mobile communication is increased, the yield of a personal information apparatus came to be increased and keep a good personal information apparatus in relation to low price readily.

Mobile communication is service that a registered personal information apparatus moves freely through service realms of mobile communication system and communicates with the opposing party that one wants in real time by wireless networking anywhere and at anytime. A personal information apparatus is compact and has been lightening.

People carry a portable terminal 24 hours a day for needs for communication that could happen anywhere and at anytime. However, availability of a portable terminal is very low because hours people used directly for communication by using voice signal is very short. To solve partly such a problem, a portable terminal having extra features such as short message service (SMS), multimedia messaging service (MMS), the management of phone number, television, recorder, calculator, camera, a global positioning system (GPS) etc. have been developing and supplying. Recently, a smart phone with the functionality of small computers has been developed. Personal digital assistants (PDA), a tablet personal computer, etc. having mobile communication capabilities, and mobile convergence encompassing another separate functions such as health diagnosis, etc. have been developed.

Generally, geographic information system (GIS) and space information is similar in concept and is mixed for use. GIS means the information system which replaces an existing map of paper with a digital map by using database and significantly uses such an information through various kinds of the software for analysis. GIS basically reaches forward to simplification of reality and started being widely used on the strength of the rapid development of computer techniques since the late 1980s. Space information which has developed on the basis of such a GIS technique is being used as a meaning referring to technique and service for new space information since 2000. First of all, with regard to the usage of space information, the direct usage made by man is transformed into the indirect usage made by object having intelligence. In case of an automobile map, a driver directly confirmed a map in the past. However, a driver has not directly a map information because a driver directly navigate a way through a navigation now. Unlike GIS, future space information reaches forward to reflecting reality as it is because the main user of space information is an object having intelligence.

In addition, modern people interact with their feelings anywhere and at anytime on the strength of the development of information technique (IT) and the progress of smart phone. However, the technique for interacting with people's feelings by using another equipment except smart phone wasn't already developed. The automobile which plays an essential role for modern people and is used plenty of time by modern people may be a means for realizing sensibility information communication technology (ICT) and modem people need the techniques related to sensibility ICT.

In addition, people need the system for sharing information between people which travel by automobile. As the culture in the value of leisure is spread, many people travel to the suburbs by automobile on holidays. In case of traveling with club people or acquaintances, many automobiles is used. By this time, club people or acquaintances gets in touch with each other frequently while traveling and shares information frequently.

For example, in case of stopping by the rest area while travelling to destinations or travelling to destinations through another way except scheduled way, people usually gets in touch with each other by telephone. Because of getting in touch with each other by telephone, all information is delivered by user's voice and it is difficult to share image information such as traffic information, map, etc.

Regarding such demands, the method and server for sharing traffic information by using mobile communication terminal (Korea Patent Publication No. 10-2012-0005178, Jan. 16, 2012), the system and method for servicing multimedia map (Korea

Patent Registration No. 10-1497994, Feb. 25, 2015), etc. is known to the public.

Such conventional techniques have an advantage to let people know a place where specific photo is filmed. However, such conventional techniques fail to provide various information regarding specific position or specific path on map (electronic map) to the public.

Accordingly, it is necessary to develop techniques for sharing experienced or acquired information regarding specific position or specific path on map (electronic map) with the opposing party or specific group in real time.

### SUMMARY OF THE INVENTION

In order to solve the aforementioned problems, an object of the present invention is to provide the system and the method for adding user generated contents such as text, graffiti, memo, file, voice, image, picture, sketch, music, video, etc. to map-based position information by using the widget of map-based editing application or by using monolithic social network service (SNS) application mounting the functions of map-based editing application while using SNS by using personal information apparatus to share with the opposing party of SNS or to share between SNS group.

An exemplary embodiment of the present invention provides a personal information apparatus for servicing map-based user generated contents for social network service, the personal information apparatus including: a memory unit for downloading, recording, installing and operating map-based content editing application and social network service application, and downloading electronic map information about current position and recording the electronic map information in allocated space;

a style editing unit for connecting with an electronic map showing coordinate information stored in the memory unit to generate user generated contents through a variety of interface; a display unit for outputting the user generated contents generated in the style editing unit; and a control unit for controlling the user generated contents, or coordinate information and property information of the user generated contents generated in the style editing unit to communicate with external server.

The personal information apparatus further including: a global positioning system (GPS) reception unit for receiving GPS signal to measuring where the GPS reception unit is positioned; a transmission unit for transmitting the user generated contents generated in the style editing unit to a real-time map engine server in accordance with control of the control unit by using map-based position information included in signal received from the GPS reception unit; a reception unit for receiving the user generated contents received from the real-time map engine server.

The personal information apparatus may downloads, records, installs and operates a monolithic social network service application mounting functions of map-based content editing application in the memory, the personal information apparatus may downloads the electronic map information and records the electronic map information in allocated space of the memory, the personal information apparatus may links one or more user generated contents inputted through the variety of interface with a corresponding position of an electronic map showing the coordinate information, and the personal information apparatus may controls to output the one or more user generated contents by a choice of user, and may records, stores and manages the one or more user generated contents.

The user generated contents may include the map-based position information having any one of text, graffiti, memo, file, voice, image, photo, picture, sketch, music or video.

The personal information apparatus may be any one of a tablet computer having communications capabilities, a smart phone, a notebook or a portable terminal.

An exemplary embodiment of the present invention provides a sharing system for servicing map-based user generated contents for social network service, the sharing system including: a personal information apparatus for servicing map-based user generated contents for social network service of any one of claims 1 to 5; a real-time map engine server receiving the map-based user generated contents generated from the personal information apparatus, or receiving coordinate information and property information from the personal information apparatus to generating the map-based user generated contents; and social network service engine server for storing in the real-time map engine server, or for transmitting the map-based user generated contents received from the personal information apparatus to another personal information apparatus.

The sharing system further including: an open street map database having parallelized map layer structure; a rendering server for extracting user position information from the open street map database and transforming the user position information into map information; a map tile server for transforming the map-based user generated contents into a real-time map image by using the user position information transformed by the rendering server; a map distribution server for distributing the a real-time map image received from the map tile server into the personal information apparatus, and for transmitting the coordinate information and the property information of the map-based user generated contents received from the personal information apparatus to the real-time map engine server and a social network service (SNS) engine server.

The social network service application installed on the personal information apparatus may be monolithic social network service application mounting functions of map-based content editing application.

An exemplary embodiment of the present invention provides a sharing system operating method for servicing map-based user generated contents for social network service that may include a personal information apparatus, a real-time map engine server and a social network service (SNS) engine server, the sharing system including: a step 1 receiving global positioning system (GPS) signal through a GPS reception unit of the personal information apparatus; a step 2 getting a position information of the personal information apparatus from the GPS signal received in the GPS reception unit; a step 3 editing map-based user generated contents by using the position information and a style editing unit; a step 4 transmitting the map-based user generated contents to a real-time map engine server by using identification information of the personal information apparatus and the position information; a step 5 transmitting the map-based user generated contents including the position information to the personal information apparatus of a other party through the identification information by using the real-time map engine server; and a step 6 receiving the map-based user generated contents from the real-time map engine server by using the personal information apparatus.

The user generated contents may include the map-based position information having any one of text, graffiti, memo, file, voice, image, photo, picture, sketch, music or video.

### BRIEF DESCRIPTION OF THE DRAWINGS

FIG. 1 is a schematic view of the whole composition of sharing system for servicing map-based user generated contents for social network service according to the exemplary embodiment of the present invention.

FIG. 2 is a diagram of the detail function component of the personal information apparatus of sharing system for servicing map-based user generated contents for social network service according to an exemplary embodiment of the present invention.

FIG. 3 is a screen for sharing user generated contents by using map-based editing application while using SNS according to the exemplary embodiment of the present invention.

FIG. 4 is a screen for sharing user generated contents by using map-based editing application while a phone call is in progress according to the exemplary embodiment of the present invention.

FIG. 5 is a diagram of the detail component of a real-time map engine server of sharing system for servicing map-based user generated contents for social network service according to an exemplary embodiment of the present invention.

FIG. 6 is a diagram of sharing system operating method for servicing map-based user generated contents for social network service according to the exemplary embodiment of the present invention.

FIG. 7 is a diagram of the detail function component of the personal information apparatus of sharing system for servicing map-based user generated contents for social network service according to an exemplary embodiment of the present invention.

FIG. 8 is a diagram of the component of the section memo information frame according to another exemplary embodiment of the present invention.

FIG. 9 is a diagram of sharing system for servicing map-based user generated contents for social network service according to another exemplary embodiment of the present invention.

FIG. 10 is a diagram of the detail function component of map access point according to an exemplary embodiment of the present invention.

FIG. 11 is a diagram of the detail function component of map uniform resource locator (URL) layer server according to an exemplary embodiment of the present invention.

FIG. 12 is a flowchart of operating method of path information routine according to the exemplary embodiment of the present invention.

FIG. 13 is a flowchart of operating method of path course search routine according to the exemplary embodiment of the present invention.

FIG. 14 is a screen having map-based user generated contents while SNS according to the exemplary embodiment of the present invention.

### DETAILED DESCRIPTION OF THE EMBODIMENTS

The present disclosure and methods of accomplishing the same may be understood more readily by reference to the following detailed description of embodiments and the accompanying drawings. However, the present disclosure may be embodied in many different forms, and should not be construed as being limited to the embodiments set forth herein. Rather, these embodiments are provided so that this disclosure will be thorough and complete and will fully convey the concept of the invention to those skilled in the art, and the present disclosure will only be defined by the appended claims.

The terminology used herein is defined in consideration of the function of corresponding components used in the present disclosure and may be varied according to users, operator's intention, or practices. In addition, an arbitrary defined terminology may be used in a specific case and will be described in detail in a corresponding description paragraph. Therefore, the terminology used herein is for the purpose of describing particular embodiments only and is not intended to be limiting of the invention.

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

Throughout the specification, unless explicitly described to the contrary, the word “comprise” and variations such as “comprises” or “comprising” will be understood to imply the inclusion of stated elements but not the exclusion of any other elements.

In addition, terms such as “unit”, which are described in the specification, means a unit of a comprehensive configuration that performs at least one function or operation.

[Exemplary Embodiment 1]

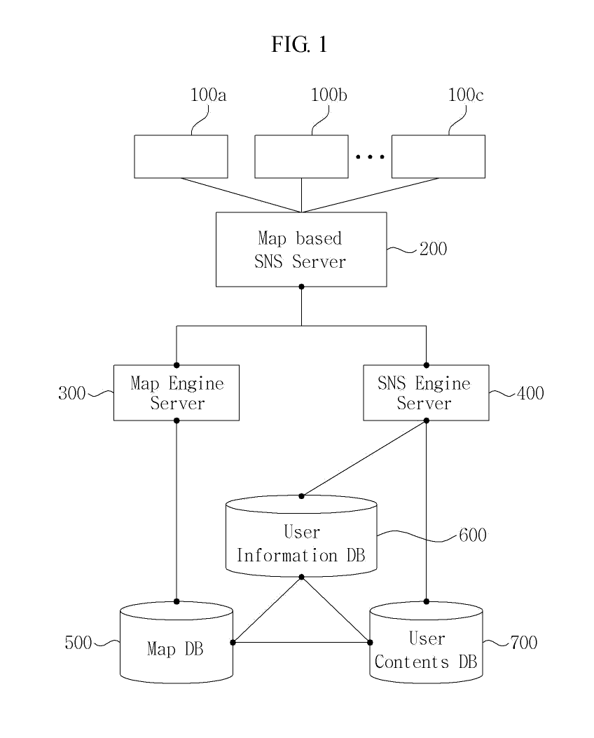

FIG. 1 is a schematic view of the whole composition of sharing system for servicing map-based user generated contents for social network service according to the exemplary embodiment of the present invention.

As illustrated in FIG. 1, the sharing system for servicing map-based user generated contents for social network service according to the exemplary embodiment of the present invention includes a personal information apparatus 100a, 100b and 100c, a map distribution server 200, a real-time map engine server 300, a social network service (SNS) engine server 400, a map database 500, a user information database 600 and a user contents database 700.

The personal information apparatus 100a, 100b and 100c downloads, records, installs and operates map-based content editing application through communication network. The personal information apparatus 100a, 100b and 100c downloads surrounding electronic map information around coordinate information about received and analyzed current position and records the electronic map information in allocated space of a memory. The personal information apparatus 100a, 100b and 100c links one or more user generated contents including voice memo, graffiti memo, letters memo, picture memo, etc. inputted through a variety of interface with a corresponding position of an electronic map showing the coordinate information. The personal information apparatus 100a, 100b and 100c controls to output the one or more user generated contents by a choice of user, and records, stores and manages the one or more user generated contents. The personal information apparatus 100a, 100b and 100c is a personal terminal apparatus capable of communication.

Application is a kind of application program and called app etc. Application mainly means application program being used by small computer, etc. Many kinds of application is steadily developed to be used in various fields. Accordingly, the name of the app is specified by developer or user. Application according to the exemplary embodiment of the present invention is called ‘map-based contents editing application’.

A widget according to the exemplary embodiment of the present invention configures wait screen around contents usually used by user. The widget is user-appropriate application program to use the desired service such as a watch, a weather, a search, a calendar, a personal schedule, a stock information, etc. immediately without being connected to portal site or contents providing sites. According to the sort and the property provided by widget, the widget is produced in various ways, by using JavaScript, Extensible Mark-up Language (XML) etc. and by using Open Application Programming Interface (Open API). The widget is loading at a faster rate than generic application program because the widget runs at wait screen.

A widget according to the exemplary embodiment of the present invention means an application program servicing the functions serviced by web browser without opening browser. Such a widget displays the map-based contents editing application on the secondary screen at wait screen.

The personal information apparatus 100a, 100b and 100c communicates with one or more personal information apparatus or different personal information apparatus of the same group through wired or wireless communication network. User activates the widget of map-based editing application through the personal information apparatus 100a, 100b and 100c while enjoying social network service. Thereby, map-based user generated contents such as text, memo, graffiti, voice, image, sketch, music, video, etc. to map-based position information is generated through the real-time map engine server 300 and the social network service (SNS) engine server 400. The user contents information is delivered to personal information apparatus of the opposing party through the map distribution server 200.

The real-time map engine server 300 is connected to the map database 500 in the form of an open street map (OSM) having parallelized map layer structure. The SNS engine server 400 is connected to the user information database 600 and the user contents database 700.

The user contents database 700 is similar to database structure of generic SNS, but configure fields to enter map data other than text. The user contents database 700 is divided into a table related to user account and a table related to map data. The table related to user account stores information related to user account and data related to access. The table related to map data stores the user generated contents such as a registered map data, a text and an image in a registered map data, comment, etc. Such a data have a registered username as foreign key.

The user generated contents is available as follows. The personal information apparatus 100a, 100b and 100c may take advantage of coordinate anywhere such as home, office, outside scene, automobile, etc. through wired or wireless communication network or mobile device. Thereby, it is possible to draw and set new flow path line on map or add the property information such as text, graffiti, memo, file, voice, image, photo, picture, sketch, music, video, etc. while views the flow path line for directions and the position during path in real time with many friends. In addition, user's voice recording information is transformed into the voice for guiding the way when automobile actually approaches the spot which user's voice is recorded on flow path line drawn by user in case user records user's voice in a certain spot. In other words, Not only the guidance for navigation by the voice recorded in a certain spot but also a variety of voice recording between friends make it possible to guide the way according to travel position of automobile.

Communication network comprises SNS and publicly known all communication network such as a wired communication network containing internet, a wireless communication network containing a mobile communication network and a wireless local area network (LAN), private communication network, etc.

The personal information apparatus 100a, 100b and 100c may be any one of a notebook computer, a personal computer, a tablet computer, a smart phone, a personal digital assistant (PDA), a portable terminal, etc.

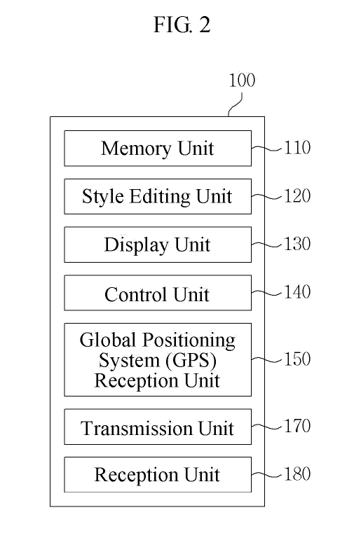

FIG. 2 is a diagram of the detail function component of the personal information apparatus of sharing system for servicing map-based user generated contents for social network service according to an exemplary embodiment of the present invention.

The personal information apparatus 100 includes a memory unit 110, a style editing unit 120, a display unit 130 and a control unit 140. In addition, the personal information apparatus 100 further includes a global positioning system (GPS) reception unit 150, a transmission unit 170 and a reception unit 180.

The memory unit 110 downloads, records, installs and operates map-based content editing application and social network service application, and downloads electronic map information about current position, and records the electronic map information in allocated space.

The style editing unit 120 connects with an electronic map showing coordinate information stored in the memory unit 110 to generate user generated contents through a variety of interface.

The display unit 130 outputs the user generated contents generated in the style editing unit 120.

The control unit 140 controls the user generated contents, or coordinate information and property information of the user generated contents generated in the style editing unit 120 to communicate with external server.

The personal information apparatus 100 further includes a global positioning system (GPS) reception unit 150, a transmission unit 170 and a reception unit 180. The GPS reception unit 150 receives GPS signal to measuring where the GPS reception unit 150 is positioned. The transmission unit 170 transmits the user generated contents generated in the style editing unit 120 to a real-time map engine server in accordance with control of the control unit by using map-based position information included in signal received from the GPS reception unit 150. The reception unit 180 receives the user generated contents received from the real-time map engine server.

In addition, the personal information apparatus 100 downloads, records, installs and operates a monolithic social network service application mounting functions of map-based content editing application in the memory. The personal information apparatus 100 downloads the electronic map information and records the electronic map information in allocated space of the memory. The personal information apparatus 100 links one or more user generated contents inputted through the variety of interface with a corresponding position of an electronic map showing the coordinate information. The personal information apparatus 100 controls to output one or more user generated contents by a choice of user, and records, stores and manages one or more user generated contents.

The user generated contents is generated to add any one of property information of text, graffiti, memo, file, voice, image, photo, picture, sketch, music or video to the map-based position information using coordinate. The personal information apparatus 100 may be any one of a tablet computer, a smart phone, a notebook or a portable terminal having communications capabilities.

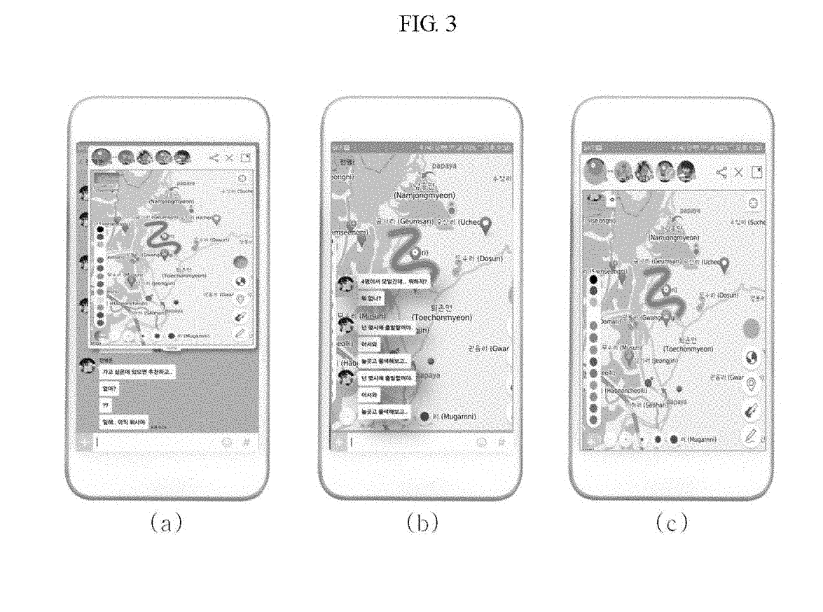

FIG. 3 is a screen for sharing user generated contents by using map-based editing application while using SNS according to the exemplary embodiment of the present invention.

In FIG. 3, (a) is a type of Widget as a screen for showing a map-based group chatting service by executing the Widget features of map-based contents editing application at a time (i.e., a way of one click or a way of one touch) while using SNS and illustrates a user experience (UX).

In FIG. 3, (b) is a screen being set at the time of map service and using a SNS chat function at a time while using a monolithic SNS application having the function of map-based contents editing application and illustrates a monolithic SNS chatting mode.

In FIG. 3, (c) is a screen for showing a full view feature during a SNS chatting at a time while using a monolithic SNS application having the function of map-based contents editing application and illustrates a monolithic map mode.

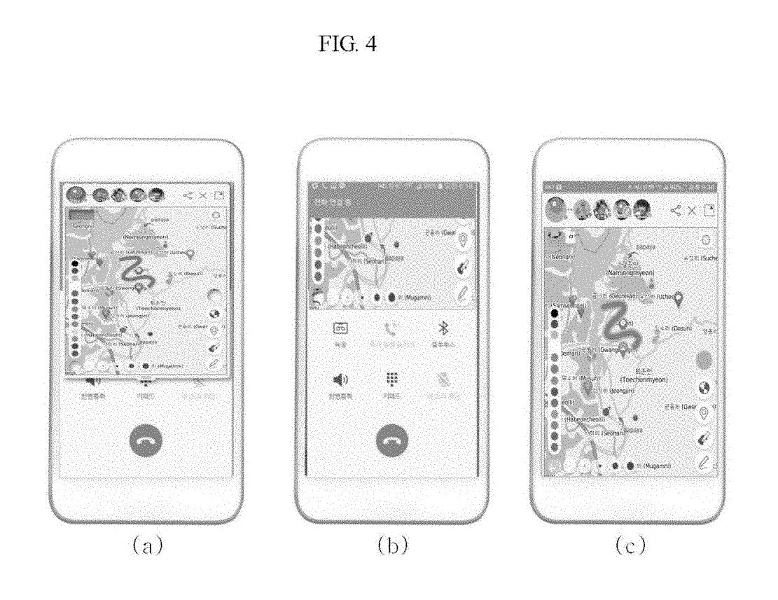

FIG. 4 is a screen for sharing user generated contents by using map-based editing application while a phone call is in progress according to the exemplary embodiment of the present invention.

In FIG. 4, (a) is a screen for map-based a phone call service by executing the Widget features of map-based contents editing application at a time i.e., a way of one click or a way of one touch) while a phone call is in progress and illustrates a user experience (UX).

In FIG. 4, (b) is a screen being set at the time of map service and using a phone call service at a time while using a monolithic SNS application having the function of map-based contents editing application and illustrates a monolithic default map mode.

In FIG. 4, (c) is a screen for showing a full view feature during a SNS chatting at a time while using a monolithic SNS application having the function of map-based contents editing application and illustrates a monolithic map mode.

By executing the Widget features of map-based contents editing application or a monolithic SNS application having the function of map-based contents editing application right allows of map-based group chatting service with the opposing party shown in a user's personal information apparatus without a separate registration. User may communicate with the opposing party using SNS easily as user explains to my friend here while drawing a picture on the map using a style editing unit. In addition, there are the advantages that user may communicate with the opposing party in real time the user generated contents, e.g. photo, video, sketch, etc. edited by reflecting real time circumstances on the actual map with one click.

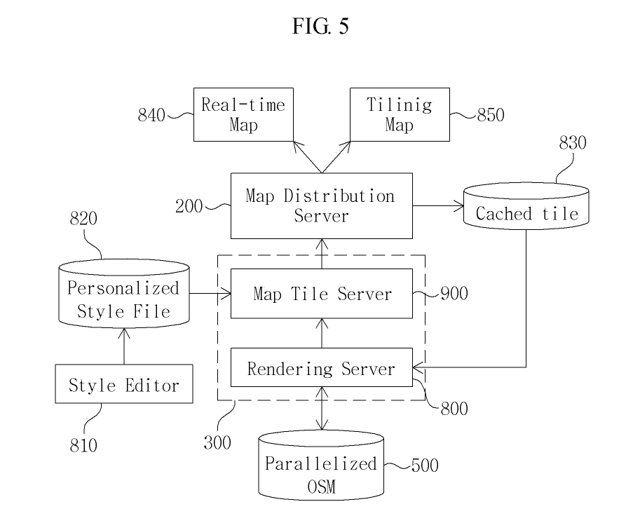

FIG. 5 is a diagram of the detail component of a real-time map engine server of sharing system for servicing map-based user generated contents for social network service according to an exemplary embodiment of the present invention.

Referring to FIGS. 1 and 5, sharing system for servicing map-based user generated contents for social network service includes a personal information apparatus 100, a real-time map engine server 300 and a social network service (SNS) engine server 400. In addition, the sharing system for servicing map-based user generated contents for social network service further includes an open street map database, a rendering server 800, a map tile server 900 and a map distribution server 200.

A real-time map engine server 300 generates user generated contents or coordinate and property information having map-based position information showing specified coordinates specified by user while using SNS by using the Widget features of map-based contents editing application, records and stores the user generated contents or coordinate and property information in allocated space, and outputs the user generated contents or coordinate and property information by request and search.

A SNS engine server 400 transmits the user generated contents stored in the real-time map engine server 300 or received from the personal information apparatus 100 to another personal information apparatus.

In addition, a sharing system for servicing map-based user generated contents for social network service may further include an open street map database 500 having parallelized map layer structure, a rendering server 800, a map tile server 900 and a map distribution server 200.

The rendering server 800 extracts an user position information from an open street map database 500 and transforms a user position information into a map information.

The map tile server 900 transforms the user generated contents into a real-time map image by using the user position information transformed by the rendering server 800.

The map distribution server 200 distributes a real-time map image received from the map tile server 900 into the personal information apparatus 100, and transmits the coordinate information and the property information of the map-based user generated contents received from the personal information apparatus 100 to the real-time map engine server 300 and the SNS engine server 400.

The rendering server 800 extracts a user position information from the open street map database 500 and transforms a user position information into a map information.

The map tile server 900 transforms the user generated contents into a real-time map image by using the user position information transformed by the rendering server 800.

The map distribution server 200 distributes a real-time map image received from the map tile server 900 into the personal information apparatus 100.

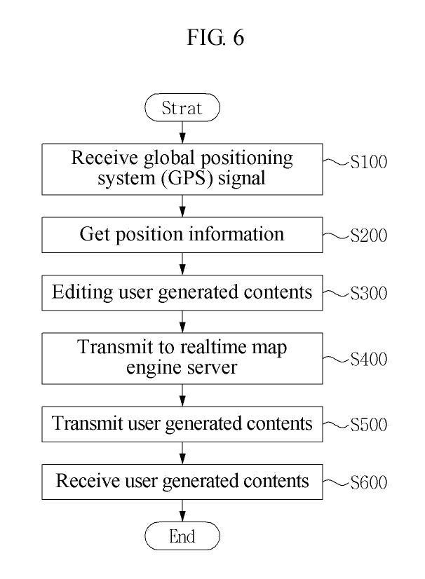

FIG. 6 is a diagram of sharing system operating method for servicing map-based user generated contents for social network service according to the exemplary embodiment of the present invention.

A sharing system operating method for servicing map-based user generated contents for social network service that includes a personal information apparatus, a real-time map engine server and a SNS engine server, the sharing system includes steps 1 to 6.

Step 1, (S100): receiving global positioning system (GPS) signal through a GPS reception unit of the personal information apparatus.

Step 2 (S200): getting a position information of the personal information apparatus from the GPS signal received in the GPS reception unit.

Step 3 (S300): editing map-based user generated contents by using the position information and a style editing unit;

Step 4 (S400): transmitting the map-based user generated contents to a real-time map engine server by using identification information of the personal information apparatus and the position information.

Step 5 (S500): transmitting the map-based user generated contents including the position information to the personal information apparatus of the opposing party via the identification information by using the real-time map engine server.

Step 6 (S600): receiving the map-based user generated contents from the real-time map engine server by using the personal information apparatus.

Accordingly, a sharing system for servicing map-based user generated contents for social network service provides the advantages of sharing map-based user generated contents generated by adding user generated contents such as text, graffiti, memo, file, voice, image, picture, sketch, music, video, etc. to map-based position information while using SNS by using personal information apparatus.

[Exemplary embodiment 2]

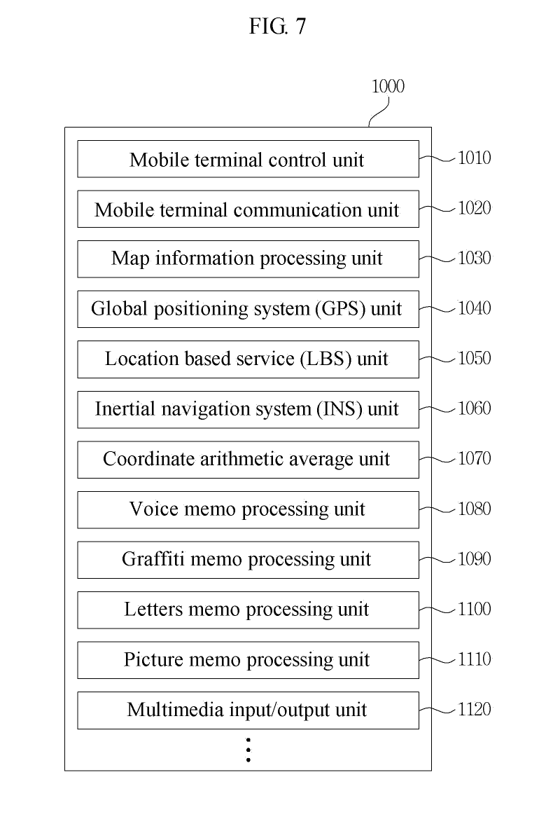

FIG. 7 is a diagram of the detail function component of the personal information apparatus of sharing system for servicing map-based user generated contents for social network service according to an exemplary embodiment of the present invention.

The personal information apparatus 1000 links one or more voice memo, graffiti memo, letters memo, path section memo information including picture memo inputted through a variety of interface such as mike, file, text message, SNS, touch panel, camera, scanner, internet search with a corresponding position of an electronic map showing the coordinate information. Thereby, the personal information apparatus 1000 displays a corresponding thumb nail image, controls to output one or more of the memos by a choice of user, and records, stores and manages one or more of memos.

The personal information apparatus 1000 may include a mobile terminal control unit 1010, a mobile terminal communication unit 1020, a map information processing unit 1030, a global positioning system (GPS) unit 1040, a location based service (LBS) unit 1050, a inertial navigation system (INS) unit 1060, a coordinate arithmetic average unit 1070, a voice memo processing unit 1080, a graffiti memo processing unit 1090, a letters memo processing unit 1100, a picture memo processing unit 1110, a multimedia input/output unit 1120.

The mobile terminal control unit 1010 controls and manages the whole operation of the personal information apparatus 1000, outputs control signal to each function unit, and monitors operation state of each function unit.

The mobile terminal control unit 1010 is operated by the activation of map-based contents editing application, as described below. In other words, the control and monitoring of the mobile terminal control unit 1010 is operated by map-based contents editing application.

The mobile terminal communication unit 1020 simultaneously communicates using any one or more of WiFi, Bluetooth or beacon while communicates using a code division multiple access (CDMA) or a wideband code division multiple access (WCDMA) by a corresponding control signal of the mobile terminal control unit 1010.

In other words, the mobile terminal communication unit 1020 not only includes the communication function unit including CDMA, WCDMA, WiFi, Bluetooth, beacon and ZigBee but also is operated in activation state.

The map information processing unit 1030 connects to a map information server 3000 by the corresponding control signal of the mobile terminal control unit 1010, and downloads electronic map information in a streaming manner, and stores the electronic map information in allocated space. The map information processing unit 1030 controls and manages the map information server 3000 to output and display electronic map information within a regular radius around specified or inputted coordinate information in a specified magnification.

The global positioning system (GPS) unit 1040 receives GPS signal from publicly known GPS satellite by the corresponding control signal of the mobile terminal control unit 1010, and operates and outputs GPS coordinate information.

The location based service (LBS) unit 1050 receives publicly known LBS signal from a mobile communication system server 7000 by the corresponding control signal of the mobile terminal control unit 1010, and operates and outputs LBS coordinate information.

The inertial navigation system (INS) unit 1060 operates and outputs inertial navigation coordinate information from inertial navigation having self-composed and publicly known mechanical composition by the corresponding control signal of the mobile terminal control unit 1010, and operates and outputs LBS coordinate information.

The coordinate arithmetic average unit 1070 inputs GPS coordinate information, LBS coordinate information and inertial navigation coordinate information respectively by the corresponding control signal of the mobile terminal control unit 1010. The result of operation performed by averaging inputted each coordinate information is outputted as the final corresponding coordinate information.

At this point, the mobile terminal control unit 1010 restrictively activates one or more GPS unit 1040, a LBS unit 1050 and an INS unit 1060. The mobile terminal control unit 1010 inputs the values of corresponding coordinate information 3 to 6 consecutive times every 0.1 seconds into a coordinate arithmetic average unit 1070 and outputs the value of operation performed by averaging the values of 3 to 6 consecutive coordinate information as the final corresponding coordinate information. In this case, it is preferable for the mobile terminal control unit 1010 to input the values of corresponding coordinate information 3 consecutive times every 0.1 seconds into a coordinate arithmetic average unit 1070 and determine the value of operation performed by averaging the values of 3 consecutive coordinate information as the final corresponding coordinate information for the reducing of the whole operation time of the personal information apparatus 1000. Even if the number of inputs of the values of corresponding coordinate information is increased, the outcome makes no odds because the values of corresponding coordinate information are within the margin of error.

The voice memo processing unit 1080 compresses a voice memo inputted to a corresponding interface by the corresponding control signal of the mobile terminal control unit 1010, and links compressed voice memo with a corresponding thumb nail image, and records the compressed voice memo as the state corresponding to a specified coordinate information. If the corresponding thumb nail image is selected, the voice memo processing unit 1080 processes the data of a compressed voice memo for the compression of the voice memo to being released and outputted. The corresponding thumb nail image includes the mark which recognizes the voice memo as follows.

The graffiti memo processing unit 1090 compresses a graffiti memo inputted to a corresponding interface by the corresponding control signal of the mobile terminal control unit 1010, and links compressed graffiti memo with a corresponding thumb nail image and records the compressed graffiti memo as the state corresponding to a specified coordinate information. If the corresponding thumb nail image is selected, the voice memo processing unit 1080 processes the data of a compressed graffiti memo for the compression of the graffiti memo to being released and outputted. The corresponding thumb nail image includes the mark which recognizes the graffiti memo as follows. A graffiti memo means fast written script, symbol, picture, etc. is scanned or shot to inputted to the graffiti memo processing unit 1090.

The letters memo processing unit 1100 compresses a letters memo inputted to a corresponding interface by the corresponding control signal of the mobile terminal control unit 1010, and links compressed letters memo with a corresponding thumb nail image, and records the compressed letters memo as the state corresponding to a specified coordinate information. The corresponding thumb nail image includes the mark which recognizes the letters memo as follows. Letters includes the text letter inputted to the letters memo processing unit 1100 in block letters or a square style.

The picture memo processing unit 1110 compresses a picture memo inputted to a corresponding interface by the corresponding control signal of the mobile terminal control unit 1010, and links compressed picture memo with a corresponding thumb nail image, and records the compressed picture memo as the state corresponding to a specific coordinate information. If the corresponding thumb nail image is selected, the picture memo processing unit 1080 processes the data of a compressed picture memo for the compression of the picture memo to being released and outputted. The corresponding thumb nail image includes the mark which recognizes the picture memo as follows. In addition, a picture image includes video, stopped image, shot image, shot picture, etc. as follows.

The multimedia input/output unit 1120 outputs a voice signal, a graffiti signal, a letters signal and a picture signal by the corresponding control signal of the mobile terminal control unit 1010. In addition, the voice signal, the graffiti signal, the letters signal and the picture signal are inputted to the multimedia input/output unit 1120 by the corresponding control signal of the mobile terminal control unit 1010.

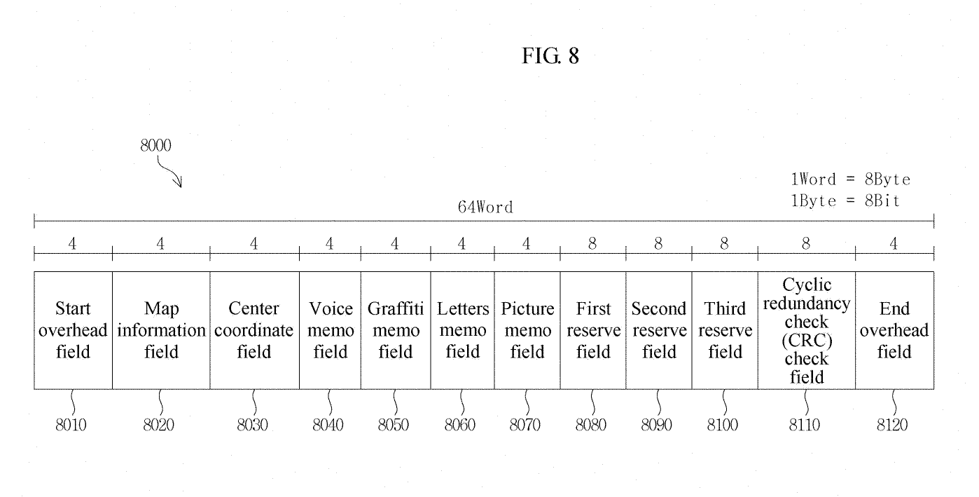

FIG. 8 is a diagram of the component of the section memo information frame according to another exemplary embodiment of the present invention.

A section memo information frame 8000 consists of a total of 64 words. 1 word is 8 bite and 1 bite is 8 bit as follows. Because the section memo information frame 8000 includes encoding, there are few concerns to being accessed by others if the configuration of word and bite is arbitrarily selected by designer.

The section memo information frame 8000 consists of a total of 12 fields. Each field includes a start overhead field 8010, a map information field 8020, a center coordinate field 8030, a voice memo field 8040, a graffiti memo field 8050, a letters memo field 8060, a picture memo field 8070, a first reserve field 8080, a second reserve field 8090, a third reserve field 8100, a cyclic redundancy check (CRC) check field 8110 and an end overhead field 8120.

In the start overhead field 8010, the start position information of the data of the section memo information frame 8000, the number of data of the section memo information frame 8000 and serial number, address information (information provider address) of the destination and stops information of the section memo information frame 8000 is recorded.

In the map information field 8020, a corresponding electronic map information of path section is compressed and recorded, or universal resource locator (URL) for the search of a corresponding electronic map is recorded.

In the center coordinate field 8030, the coordinate information finally operated and outputted by a personal information apparatus and being around a map information (electronic map information) displaying a path section is recorded with a corresponding time information.

In the voice memo field 8040, all voice memo signals inputted and recorded while displaying a path section are recorded with a corresponding time information.

In the graffiti memo field 8050, all graffiti memo signals inputted and recorded while displaying a path section are recorded with a corresponding time information.

In the letters memo field 8060, all letters memo signals inputted and recorded while displaying a path section are recorded with a corresponding time information.

In the picture memo field 8070, all picture memo signals inputted and recorded while displaying a path section are recorded with a corresponding time information.

In the first reserve field 8080, the map information field 8020, the center coordinate field 8030, the voice memo field 8040, the graffiti memo field 8050, the letters memo field 8060 and the picture memo field 8070 is compressed and recorded.

In the second reserve field 8090, the map information field 8020, the center coordinate field 8030, the voice memo field 8040, the graffiti memo field 8050, the letters memo field 8060 and the picture memo field 8070 is compressed and recorded. In the second reserve field 8090, the same contents as the first reserve field 8080 is recorded.

The third reserve field 8100 is left blank for expandability.

A CRC check field 8110 checks the data of the section memo information frame 8000 for errors by using publicly known CRC check method. If an error occurred in the data of the section memo information frame 8000, the CRC check field 8110 recovers from error. Failing to recover from error, the CRC check field 8110 attempts to recover from error again by using hamming code method. Failing to recover from error even by using hamming code method, the CRC check field 8110 displays the signs of needing the retransmission of the data of the section memo information frame 8000 and records the necessary information for transmission side to transmit the data of the section memo information frame 8000 of a corresponding serial number again. Recovering from error by using hamming code method, the CRC check field 8110 does not record the signs of needing the retransmission of the data of the section memo information frame 8000.

In an end overhead field 8120, the end position information of the data of the section memo information frame 8000 and the transmission destination information is recorded.

Because the record of an information in the section memo information frame 8000 encodes the section memo information frame 8000, it is impossible to extract an exact information from the section memo information frame 8000 in case the structure of the section memo information frame 8000 is not recognized. Accordingly, the mobile terminal control unit 1010 encodes or decodes the section memo information frame 8000 as follows.

[Exemplary embodiment 3]

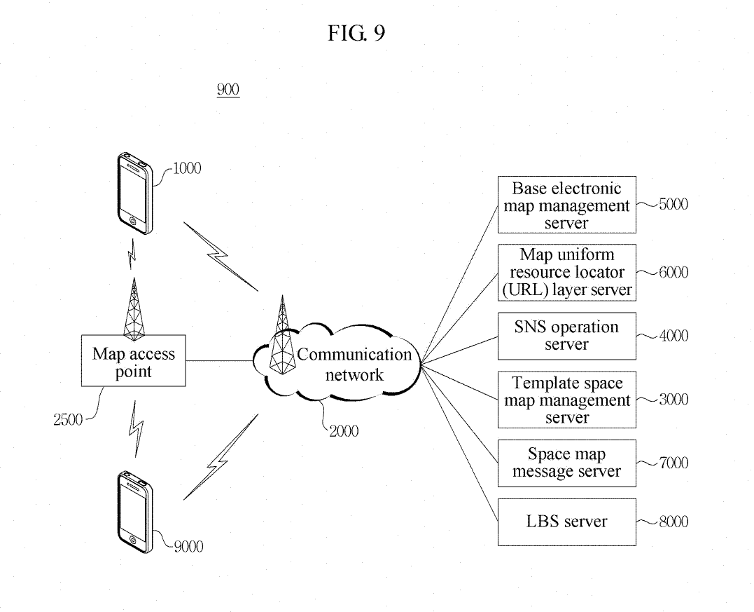

FIG. 9 is a diagram of sharing system for servicing map-based user generated contents for social network service according to another exemplary embodiment of the present invention.

Application is a kind of application program (software). Application is called app etc. and used in many different application area. Application is mainly used to refer to application program with small capacity used in a notebook, a data terminal and a smart phone etc. A notebook, a data terminal and a smart phone etc. have a central processing unit (CPU), a memory and the poor levels of performance of capabilities unit. It is common for user or developer to arbitrarily attach a name that is appropriate for application area and easy to call to application because there are many kinds and a wide variety of application area. The present invention relates to a map (an electronic map) and the map relates to space information, thereby the name of application is called ‘map-based contents editing application’ as follows.

A first map portable terminal 1000 and a second map portable terminal 9000 have the same configuration, capabilities and action, thereby the present invention centers round the first map portable terminal 1000 to avoid duplicated explanation.

The first map portable terminal 1000 downloads electronic map and map-based contents editing application which is the basis of a first map portable terminal 1000 wirelessly, and links experienced or learned region environment information with regard to current zones or specific zones with designed template, and displays the region environment information on the corresponding position of electronic map. Thereby, the first map portable terminal 1000 transforms edited user map into map environment frame, uploads transformed map environment frame and controls the transformed map environment frame to share the transformed map environment frame with the opposing party in SNS in real-time.

A map access point 2500 includes beacon, WiFi, Bluetooth, ZigBee and wireless capabilities unit having radio frequency identification (RFID) method. The map access point 2500 activates two or more wireless capabilities unit selected by the corresponding control signal simultaneously, thereby communicates with the first map portable terminal 1000 or the second map portable terminal 9000 wirelessly. Beacon, WiFi, Bluetooth, ZigBee and RFID method etc. is publicly known, thereby their detailed descriptions are left out.

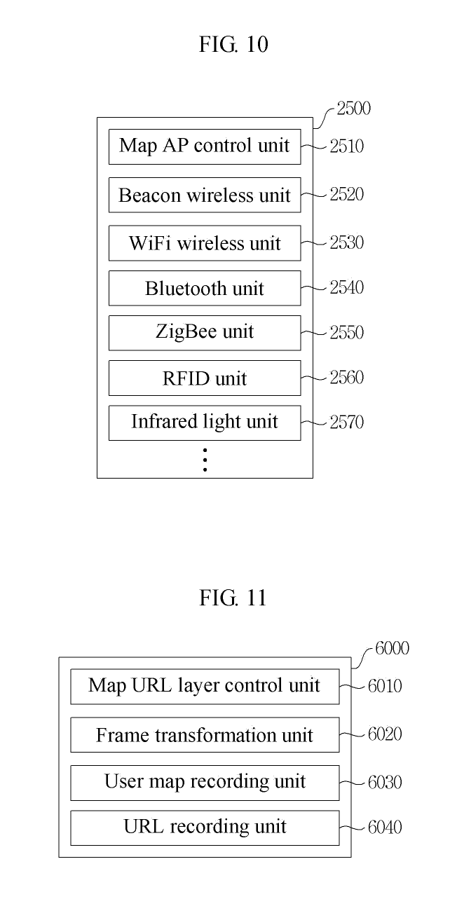

FIG. 10 is a diagram of the detail function component of map access point according to an exemplary embodiment of the present invention.

A map access point 2500 includes a map access point (AP) control unit 2510, a beacon wireless unit 2520, a WiFi wireless unit 2530, a Bluetooth unit 2540, a ZigBee unit 2550, a RFID unit 2560 and an infrared light unit 2570.

The map access point (AP) control unit 2510 monitors and controls the management of each capabilities unit configured for the map access point 2500.

The beacon wireless unit 2520 is operated in activation state by the corresponding control signal of the map AP control unit 2510, and connects to the first map portable terminal 1000 or the second map portable terminal 9000 through beacon to transmit/receive communication signal including a map environment frame having user map information.

The WiFi wireless unit 2530 is operated in activation state by the corresponding control signal of the map AP control unit 2510, and connects to the first map portable terminal 1000 or the second map portable terminal 9000 through WiFi to transmit/receive communication signal including a map environment frame having user map information.

The bluetooth unit 2540 is operated in activation state by the corresponding control signal of the map AP control unit 2510, and connects to the first map portable terminal 1000 or the second map portable terminal 9000 through Bluetooth to transmit/receive communication signal including a map environment frame having user map information.

The ZigBee unit 2550 is operated in activation state by the corresponding control signal of the map AP control unit 2510, and connects to the first map portable terminal 1000 or the second map portable terminal 9000 through ZigBee to transmit/receive communication signal including a map environment frame having user map information.

The RFID unit 2560 is operated in activation state by the corresponding control signal of the map AP control unit 2510, and connects to the first map portable terminal 1000 or the second map portable terminal 9000 through RFID to transmit/receive communication signal including a map environment frame having user map information.

The infrared light unit 2570 is operated in activation state by the corresponding control signal of the map AP control unit 2510, and connects to the first map portable terminal 1000 or the second map portable terminal 9000 through infrared light communication to transmit/receive communication signal including a map environment frame having user map information.

Beacon is the latest Bluetooth communication method and Bluetooth is conventional communication method as follows.

The first map portable terminal 1000 or the second map portable terminal 9000 is simultaneously connected to two or more wireless communication capabilities unit of the map access point 2500 through beacon, WiFi, Bluetooth, ZigBee or RFID while connecting to each other wirelessly using mobile communication method of any one of communication network, a code division multiple access (CDMA) or a wideband code division multiple access (WCDMA), trunked radio system (TRS) or single sideband frequency (SSB). Accordingly, a first map portable terminal 1000 or the second map portable terminal 9000 is simultaneously connected to the map access point 2500 through three or more wireless channel (path) at a time and transmits/receives the same signal through each channel, thereby it is possible to minimize transmission errors and transmit/receive user map information without transmission errors even in bad wireless environment such as city for building etc.

A communication network 2000 includes a map access point 2500 as follows, and is divided and explained within a context.

A template space map management server 3000 connects to the first map portable terminal 1000 through the communication network 2000 or the map access point 2500, downloads the latest map-based contents editing application in a streaming manner, and controls and monitors the whole operation of sharing system for servicing map-based user generated contents using Widget while using SNS.

A SNS operation server 4000 connects to a template space map management server 3000 through the communication network 2000, sets and activates SNS communication channel by control or request of the first map portable terminal 1000.

A base electronic map management server 5000 records and stores electronic map information which is the basis of a base electronic map management server 5000, connects to the first map portable terminal 1000 through the communication network 2000 and downloads a corresponding electronic map of a selected specific zone or current zone of the first map portable terminal 1000 in a streaming manner by control or request of the first map portable terminal 1000.

A base electronic map management server 5000 provides map information on a scale of 1:5000 within a 1 to 20 km radius around specific coordinate information by control of the template space map management server 3000. The base electronic map management server 5000 provides map information within a corresponding radius relative to a changed coordinate information in case coordinate information is changed. Accordingly, the first map portable terminal 1000 having limited memory resource is not insufficient memory.

A map uniform resource locator (URL) layer server 6000 connects to the first map portable terminal 1000 through the communication network 2000. The first map portable terminal 1000 uploads user map information composed of region environment information linked with an electronic map corresponding specified position and a designed template to a map environment frame in real time. A map URL layer server 6000 extracts a user map from a map environment frame, and records and stores the user map in allocated space, and provides the user map in real time. The map URL layer server 6000 links the user map with the specified URL address and records and stores the user map. If URL address is searched, the map URL layer server 6000 transforms a corresponding user map information into a map environment frame composed 64 words and provides a transformed user map information.

URL address is the address of internet site and a corresponding address is directly inputted. However, a corresponding address is recognized as quick response (QR) code, bar code etc. and automatically inputted. Such a technique is publicly known, thereby detail description is omitted.

FIG. 11 is a diagram of the detail function component of map URL layer server according to an exemplary embodiment of the present invention.

A map URL layer server 6000 includes a map URL layer control unit 6010, a frame transformation unit 6020, a user map recording unit and an URL recording unit 6040.

The map URL layer control unit 6010 controls and monitors each capabilities unit of the map URL layer server 6000.

The frame transformation unit 6020 transforms a user map information into a map environment frame or extract the user map information from the map environment frame by a corresponding control signal of the map URL layer control unit 6010.

The user map recording unit 6030 records and stores the user map information extracted from the map environment frame in allocated space by a corresponding control signal of the map URL layer control unit 6010, and provides the user map information by search. The user map information provided by search is inputted to the frame transformation unit 6020 by a corresponding control signal of the map URL layer control unit 6010, thereby is provided as state transformed into the map environment frame.

The URL recording unit 6040 records and stores the address of internet site and URL address, allowing user to directly check each user map recorded and stored in the user map recording unit 6030 by a corresponding control signal of the map URL layer control unit 6010. Such an URL address is linked with a corresponding user map stored in the user map recording unit 6030, and recorded and stored in the URL recording unit 6040.

A space map message server 7000 connects to the first map portable terminal 1000 through the communication network 2000, and records and stores in allocated space of the map URL layer server 6000 by a corresponding control signal of the template space map management server 3000. The space map message server 7000 transforms searched user map into map environment frame, and transforms the map environment frame using message method used in mobile system, and transmits a transformed map environment frame to a second map portable terminal 9000 specified as the opposing party.

A location based service (LBS) server 8000 connects to the first map portable terminal 1000 through the communication network 2000 and provides LBS position information using LBS service by request. A LBS service is publicly known, thereby detail description is omitted.

[Exemplary embodiment 4]

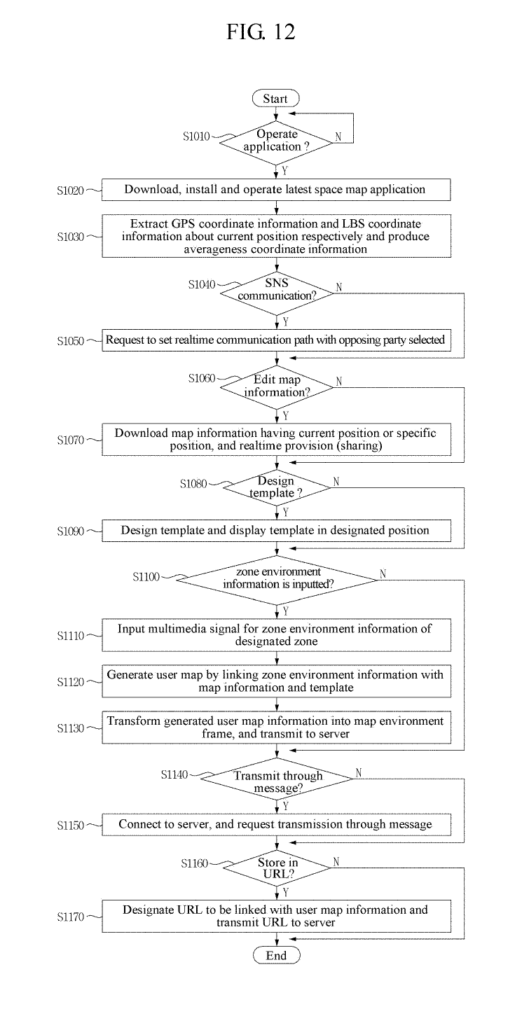

FIG. 12 is a flowchart of operating method of path information routine according to the exemplary embodiment of the present invention. The exemplary embodiment of the present invention will be described more fully hereinafter with reference to the accompanying drawings.

A sharing system operating method for servicing map-based user generated contents using Widget while using SNS is explained as follows. A sharing system for servicing map-based user generated contents using Widget while using SNS includes a first map portable terminal 1000, a communication network 2000, a map access point 2500, a template space map management server 3000, a SNS operation server 4000, a base electronic map management server 5000, a map URL layer server 6000, a space map message server 7000, a location based service (LBS) server 8000 and a second map portable terminal 9000.

A first map portable terminal determines whether or not a corresponding control signal or request signal for operating map-based contents editing application is inputted (S1010).

If a first map portable terminal determines that a corresponding control signal or request signal for operating map-based contents editing application is inputted, a first map portable terminal connects to a template space map management server, downloads the latest map-based contents editing application in a streaming manner, and records, installs and operates the latest map-based contents editing application (S1020).

Here, if a first map portable terminal determines that the latest map-based contents editing application is installed and being operated, or is installed in an operable state, a first map portable terminal receives, analyzes and extracts GPS coordinate information and LBS coordinate information about a current position at the same time respectively, averages GPS coordinate information and LBS coordinate information respectively, and produces averageness coordinate information (S1030).

A first map portable terminal may output any one or more of GPS coordinate information, LBS coordinate information and averageness coordinate information.

A first map portable terminal extracts GPS coordinate information, LBS coordinate information, averageness coordinate information, previously explained precision averageness coordinate information and a secondary averageness coordinate information at time unit of a short interval of period, i.e. in 0.1˜1 seconds. Any one of such coordinates is used as position (coordinate) information about a current position. As such, the coordinate information having improved accuracy further improves the reliability of a map information.

A first map portable terminal analyzes an inputted control signal. If a first map portable terminal determines that a first map portable terminal is using SNS (S1040), a first map portable terminal controls and monitors template space map management server to connect to template space map management server, to connect to one or more of the opposing party or a second map portable terminal in real time, and to set and be maintained information sharing (S1050).

A first map portable terminal analyzes an inputted control signal. If a first map portable terminal determines that a first map portable terminal is editing map information, a first map portable terminal controls and monitors the template space map management server to connect the template space map management server and to download electronic map information about current position or specific position. A first map portable terminal controls and monitors the template space map management server to display a designed template at the specific position, and inputs the environment information of a specific zone through multimedia. A first map portable terminal controls and monitors the template space map management server to link electronic map information, the designed template or the environment information with each other, to generate user map information, to transform user map information into a map environment frame, and to transmit and be record a map environment frame.

Specifically, a first map portable terminal determines that control signal or command signal regarding the editing of map information is inputted in a first map portable terminal (S1060), a first map portable terminal controls and monitors the template space map management server to download the map information having a current position of a first map portable terminal or (inputted) specific position from base engine electronic map server in a streaming manner (S1070).

A first map portable terminal determines that control signal or command signal regarding the design of template is inputted in a first map portable terminal (S1080), a first map portable terminal controls and monitors the template space map management server to design template with any one or more of color, mark or sign selected by a corresponding control signal, and controls and monitors the template space map management server to display template in the designated position of map information (S1090).

A first map portable terminal determines that control signal regarding the input of zone environment information is inputted in a first map portable terminal (S1100), a first map portable terminal inputs one or more multimedia signal of image signals including audio, video and symbol characters for zone environment information of the designated zone (S1110).

A first map portable terminal links zone environment information inputted multimedia signal with the designated template and map information, generates user map information (S1120), transforms generated user map information into map environment frame, and transmits the template space map management server. Thereby, a first map portable terminal controls and monitors the template space map management server for transformed map environment frame to be recorded and stored in allocated space of map URL layer server (S1130).

If a first map portable terminal determines that analyzed command signal is the control signal that user map information transmits to the opposing party (designated) or a second map portable terminal through message, a first map portable terminal connects to the template space map management server, and controls and monitors the template space map management server for user map information to be transmitted through message (S1150).

A first map portable terminal determines that analyzed command signal is the control signal that user map information is linked with URL address and stored (S1160), a first map portable terminal connect to the template space map management server, and controls and monitors the template space map management server for user map information to be linked with URL address and stored (S1170).

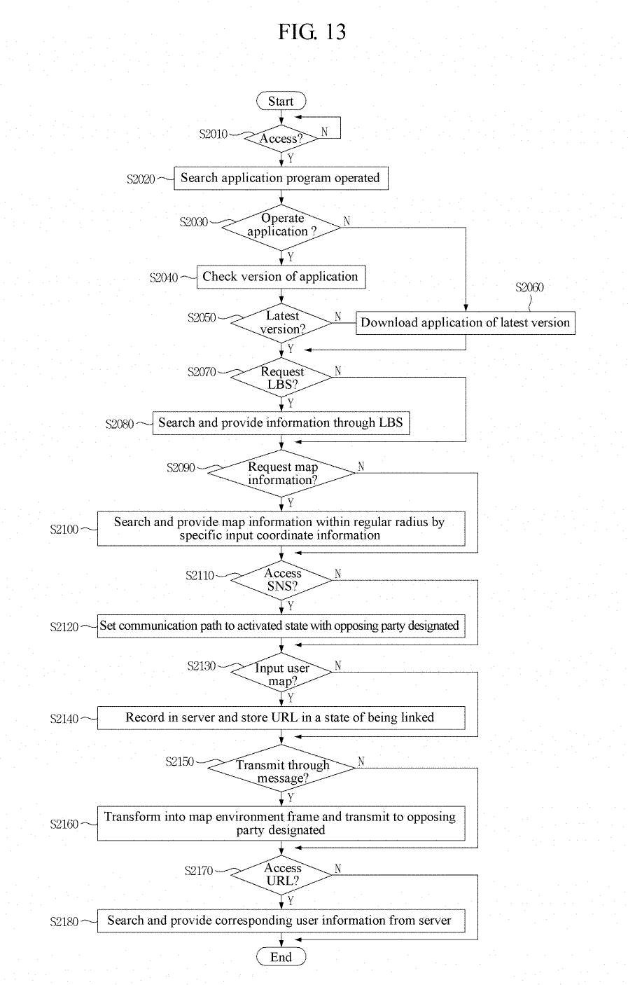

FIG. 13 is a flowchart of operating method of path course search routine according to the exemplary embodiment of the present invention.

The template space map management server determines that the first map portable terminal connects to the template space map management server (S2010), the template space map management server searches application program operated by the first map portable terminal through remote wireless access (S2020).

The template space map management server determines that the first map portable terminal installs and operates map-based contents editing application (S2030), the template space map management server checks the version of application (S2040) and determine that the version of application is the latest version (S2050).

The template space map management server determines that the version of application operated by the first map portable terminal is not the latest version, or a map-based contents editing application is not operated, the template space map management server transmits the latest version of map-based contents editing application to the first map portable terminal in a download manner, thereby the latest version of map-based contents editing application is installed and operated in the first map portable terminal (S2060).

The template space map management server analyzes signal inputted from the first map portable terminal. If the template space map management server determines that inputted signal is request signal for LBS service (S2070), the template space map management server connects to LBS server and controls LBS server to provide current position information of the first map portable terminal through LBS service (S2080).

The template space map management server analyzes signal inputted from the first map portable terminal. If the template space map management server determines that inputted signal is request signal for an elementary map information (S2090), the template space map management server searches map information within a regular radius from base electronic map management server by a specific input coordinate information and downloads information within a regular radius in a streaming method (S2100).

The template space map management server analyzes signal inputted from the first map portable terminal. If the template space map management server determines that inputted signal is request signal for SNS access (S2110), the template space map management server connects to SNS operating server, and controls SNS operating server to connect to one or more of the opposing party or the second map portable terminal through communication path, to be set to activated state and to maintain activated state (S2120).

The template space map management server analyzes signal inputted from the first map portable terminal. If the template space map management server determines that inputted signal is inputted by uploading user map information (S2130), the template space map management server connects a map URL layer server, and controls a map URL layer server to record inputted signal in allocated space, and to record and store URL address inputted by uploading user map information in a state of being linked with the first map portable terminal (S2140).

The template space map management server analyzes signal inputted from the first map portable terminal. If the template space map management server determines that inputted signal is a signal which a message transformed from user information is transmitted to the opposing party designated or the second map portable terminal (S2150), the template space map management server connects to a space map message server and controls the space map message server for user map information to be transmitted to the opposing party designated or the second map portable terminal through message (S2160).

The template space map management server analyzes signal inputted from the first map portable terminal. If the template space map management server determines that inputted signal is connected to URL address (S2170), the template space map management server connects to a map URL layer server and controls a map URL layer server to search and provide a corresponding user information linked with URL address and stored (S2180).

A sharing system operating method for servicing map-based user generated contents for social network service that includes a personal information apparatus of the present invention will be described more fully hereinafter with reference to the accompanying drawings.

Here, a sharing system for servicing map-based user generated contents for social network service that includes a personal information apparatus of the present invention includes a personal information apparatus 1000, a communication network 2000, a template space map management server 3000, a SNS operation server 4000, a base electronic map management server 5000, a map URL layer server 6000 and a space map message server 7000.

In case of the operation of graffiti path service using a personal information apparatus (S1010), a mobile terminal control unit of a personal information apparatus determines whether or not a map-based editing application is installed and operated in a personal information apparatus (S1020).

If the map-based editing application is not installed and operated in a personal information apparatus, the mobile terminal control unit connects to a path memo information server, downloads the latest version of map-based contents editing application wirelessly in a streaming manner, and records, stores, automatically installs downloaded map-based contents editing application in allocated space, and automatically sets downloaded map-based contents editing application in an operating state (S1030).

Meanwhile, a mobile terminal control unit connects to a path memo information server by periods, e.g. 24 hours or 0 hour every day, and downloads the latest version of map-based contents editing application wirelessly in a streaming manner. Such a series of process works automatically.

In case of the generation of graffiti path course using a personal information apparatus (S1040), the mobile terminal control unit decides a ground zero and a place of arrival of graffiti path course, searches map information and outputs searched map information to be records, stores and displayed (S1050).

In case the graffiti path course information generated by a personal information apparatus is shared with the personal information apparatus in real-time (S1060), the mobile terminal control unit designates or sets a personal information apparatus corresponding to shared targets of groups view to a slave, and designates or sets each personal information apparatus to be connected to communication path of medium preferred or registered by each personal information apparatus (S1070).

The mobile terminal control unit registers a list of master candidate to be converted into personal information apparatus from a support target to a specified target, records and stores the list of master candidate in autonomously allocated space, and records, stores and manages the list of master candidate in allocated space of path memo information server (S1080).

In case the graffiti path is started by a personal information apparatus (S1090), the mobile terminal control unit operates or executes a path information routine (S1100). A path information routine will be described in detail as follows.

In case the graffiti path is ended by a personal information apparatus (S1100), the mobile terminal control unit transforms a path section memo information recorded in graffiti path section into a path memo information frame, and records, stores and manages transformed path memo information frame in autonomously allocated memory space by unit file, and controls or requests path memo information server to record, store and manage transformed path memo information frame in path memo information server (S1120), and controls the path memo information server to be respectively transmitted to each target or each member of public groups through communication path by each designated medium of the personal information apparatus (S1130).

Meanwhile, in case the graffiti path course information is not generated by a personal information apparatus (S1040), the mobile terminal control unit controls and monitors the path memo information server to operate the graffiti path course search routine (S1140). The graffiti path course search routine will be described in detail as follows.

Describing path information routine in detail, the mobile terminal control unit 1010 of the personal information apparatus drives a GPS unit 1040, and a LBS unit 1050, an INS unit 1060 and a coordinate arithmetic mean unit 1070 respectively to be activated, and outputs finally operated coordinate information, and sets outputted coordinate information to the center position of electronic map, and designates level value indicating the magnification of displayed map (S2010).

In other words, path information routine processed by the personal information apparatus includes the process which drives a GPS unit 1040, a LBS unit 1050 and an INS unit 1060 to be activated, and sets operated coordinate information to be in the center position of outputted coordinate information, and transmits to targets of groups view for designated magnification, thereby sharing operated coordinate information with targets of groups view.

If the mobile terminal control unit does not designate the level value, the level value is automatically designated to a level value to display the electronic map of the whole path section on one screen.

If the personal information apparatus included in targets of groups view selects alone view (S2020), the personal information apparatus is separated from groups view, and controls and monitors for alone view mode to be operated (S2030), and requests for map information server to search the map information of the graffiti path course for alone view (S2040).

The personal information apparatus may operates alone view mode while the personal information apparatus is operated as a master. However, detail description is omitted.

In case the personal information apparatus try to comeback to groups view mode from alone view mode, because the personal information apparatus ends alone view mode and comeback to groups view mode from alone view mode, thereby the control status of the personal information apparatus is appreciated without modification by user (S2060).

Changing a path from a ground zero to a place of arrival of graffiti path course, the personal information apparatus shares the path in real-time (S2070), and links multimedia contents including graffiti, recording, memo and image with coordinate information and summarized thumb nail image, and records, stores and manages the multimedia contents (S2080).

In case the personal information apparatus transmits recorded information to public groups (S2090), the personal information apparatus transmits recorded recording information to each designated communication media of shared targets of groups view (S2100).

Here, recorded information is recorded in a master mobile terminal, and record, stored and managed exactly to a path memo information server.

The mobile terminal control unit or map-based editing application of the personal information apparatus measures elapsed time after the personal information apparatus finally input information or inputs control signal or operating signal (S2110).

Measuring that a first allowed time elapses after final connect hours that control signal etc. was inputted by the personal information apparatus (S2120), the mobile terminal control unit or map-based editing application specifies the next order shared targets of the list of master candidate as a master (S2130) and path information routine is ended, thereby is returned to start.

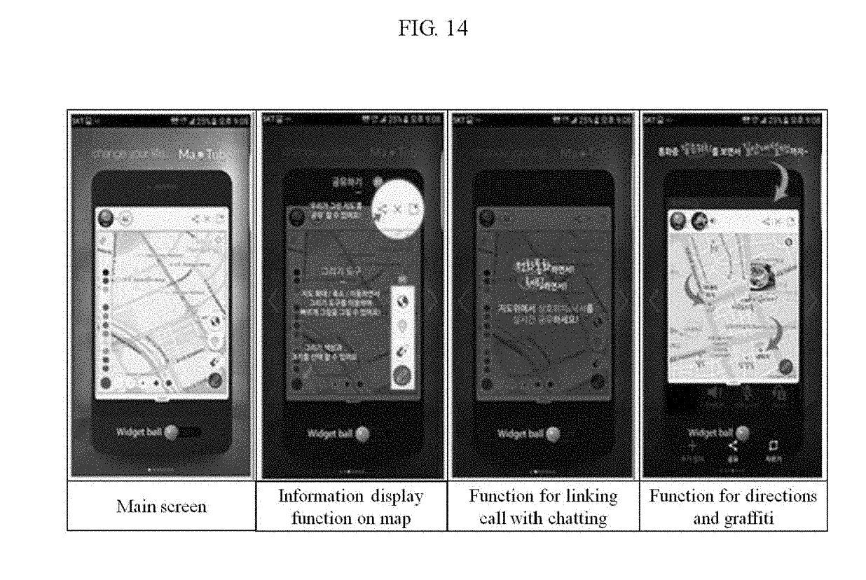

FIG. 14 is a screen having map-based user generated contents while SNS according to the exemplary embodiment of the present invention. As shown in FIG. 14, user sets (designs) path on the electronic map, and connects multimedia contents such as photo, text, voice, image etc. to every key point or every key position on designed path, and enters and registers the multimedia contents in every key point or every key position, and sharing the multimedia contents as extra contents, or the notion for an easy recognition of a corresponding path as a continuous flow by providing a variety of contents according to position and time sequence is illustrated.

Meanwhile, parties in a communication may share a product of a map, or a designed map provided to another designated party. Parties in a communication shares the same map (level and center position is equal) with one or more of the opposing party in real-time, and a personal information apparatus of user or the opposing party shares gained information including position indication, graffiti, memo, image etc. inputted through a variety of interface. The personal information apparatus of user or the opposing party shares the gained information through shared map.

In addition, in case the personal information apparatus is registered as a member of shared targets, the personal information apparatus registers application or communication medium in use and is selectively processed to communicate with another personal information apparatus through a corresponding communication medium. In case the personal information apparatus communicate with another personal information apparatus (shared targets) or user, the personal information is selectively processed to be communicated with another personal information apparatus (shared targets) or user through registered application or communication medium.

Meanwhile, the present invention provides a technique for user to records, stores, provides and shares information which user finds or acquires from the selected position of the map as contents such as memo etc. while communicating the opposing party through a phone call, instant message service, mail, SNS etc.

In addition, parties in a communication may share a product of a map, or a designed map provided to another designated party. After transmitting path information of map, the personal information apparatus needs to transmit contents of addition or supplementation.

According to the exemplary embodiment of the present invention, it is possible to provide the advantages adding user generated contents such as text, graffiti, memo, file, voice, image, picture, sketch, music, video, etc. to map-based position information by using the widget of map-based editing application or by using monolithic social network service (SNS) application mounting the functions of map-based editing application while using SNS by using personal information apparatus to share with the opposing party of SNS or to share between SNS group.

In addition, a total of hours for usage of map-based user generated contents is reduced on the strength of reducing clicks by sharing map-based user generated contents between different users in real-time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A personal information apparatus for servicing map-based user generated contents for social network service, the personal information apparatus comprising:
a memory unit for downloading, recording, installing and operating map-based content editing application and social network service application, and downloading electronic map information about current position and recording the electronic map information in allocated space;
a style editing unit for connecting with an electronic map showing coordinate information stored in the memory unit to generate user generated contents through a variety of interface;
a display unit for outputting the user generated contents generated in the style editing unit; and
a control unit for controlling the user generated contents, or coordinate information and property information of the user generated contents generated in the style editing unit to communicate with external server.

2. The personal information apparatus of claim 1, further comprising:
a global positioning system (GPS) reception unit for receiving GPS signal to measuring where the GPS reception unit is positioned;
a transmission unit for transmitting the user generated contents generated in the style editing unit to a real-time map engine server in accordance with control of the control unit by using map-based position information included in signal received from the GPS reception unit; and
a reception unit for receiving the user generated contents received from the real-time map engine server.

3. The personal information apparatus of claim 1,
wherein the personal information apparatus downloads, records, installs and operates a monolithic social network service application mounting functions of map-based content editing application in the memory,
wherein the personal information apparatus downloads the electronic map information and records the electronic map information in allocated space of the memory,
wherein the personal information apparatus links one or more user generated contents inputted through the variety of interface with a corresponding position of an electronic map showing the coordinate information, and
wherein the personal information apparatus controls to output the one or more user generated contents by a choice of user, and records, stores and manages the one or more user generated contents.

4. The personal information apparatus of claim 1, wherein the user generated contents include the map-based position information having any one of text, graffiti, memo, file, voice, image, photo, picture, sketch, music or video.

5. The personal information apparatus of claim 1, wherein the personal information apparatus is any one of a tablet computer having communications capabilities, a smart phone, a notebook or a portable terminal.

6. A sharing system for servicing map-based user generated contents for social network service, the sharing system comprising:
a personal information apparatus for servicing map-based user generated contents for social network service of claim 1;
a real-time map engine server receiving the map-based user generated contents generated from the personal information apparatus, or receiving coordinate information and property information from the personal information apparatus to generating the map-based user generated contents; and
a social network service engine server for storing in the real-time map engine server, or for transmitting the map-based user generated contents received from the personal information apparatus to another personal information apparatus.

7. A sharing system for servicing map-based user generated contents for social network service, the sharing system comprising:
a personal information apparatus for servicing map-based user generated contents for social network service of claim 2;
a real-time map engine server receiving the map-based user generated contents generated from the personal information apparatus, or receiving coordinate information and property information from the personal information apparatus to generating the map-based user generated contents; and
a social network service engine server for storing in the real-time map engine server, or for transmitting the map-based user generated contents received from the personal information apparatus to another personal information apparatus.

8. A sharing system for servicing map-based user generated contents for social network service, the sharing system comprising:
a personal information apparatus for servicing map-based user generated contents for social network service of claim 3;
a real-time map engine server receiving the map-based user generated contents generated from the personal information apparatus, or receiving coordinate information and property information from the personal information apparatus to generating the map-based user generated contents; and
a social network service engine server for storing in the real-time map engine server, or for transmitting the map-based user generated contents received from the personal information apparatus to another personal information apparatus.

9. The sharing system of claim 6, further comprising:
an open street map database having parallelized map layer structure;
a rendering server for extracting user position information from the open street map database and transforming the user position information into map information;
a map tile server for transforming the map-based user generated contents into a real-time map image by using the user position information transformed by the rendering server;
a map distribution server for distributing a real-time map image received from the map tile server into the personal information apparatus, and for transmitting the coordinate information and the property information of the map-based user generated contents received from the personal information apparatus to the real-time map engine server and a social network service (SNS) engine server.

10. The sharing system of claim 7, further comprising:
an open street map database having parallelized map layer structure;
a rendering server for extracting user position information from the open street map database and transforming the user position information into map information;
a map tile server for transforming the map-based user generated contents into a real-time map image by using the user position information transformed by the rendering server;
a map distribution server for distributing a real-time map image received from the map tile server into the personal information apparatus, and for transmitting the coordinate information and the property information of the map-based user generated contents received from the personal information apparatus to the real-time map engine server and a social network service (SNS) engine server.

11. The sharing system of claim 8, further comprising:
an open street map database having parallelized map layer structure;
a rendering server for extracting user position information from the open street map database and transforming the user position information into map information;
a map tile server for transforming the map-based user generated contents into a real-time map image by using the user position information transformed by the rendering server;
a map distribution server for distributing a real-time map image received from the map tile server into the personal information apparatus, and for transmitting the coordinate information and the property information of the map-based user generated contents received from the personal information apparatus to the real-time map engine server and a social network service (SNS) engine server.

12. The sharing system of claim 6, wherein social network service application installed on the personal information apparatus is monolithic social network service application mounting functions of map-based content editing application.

13. The sharing system of claim 7, wherein social network service application installed on the personal information apparatus is monolithic social network service application mounting functions of map-based content editing application.

14. The sharing system of claim 8, wherein social network service application installed on the personal information apparatus is monolithic social network service application mounting functions of map-based content editing application.

15. A sharing system operating method for servicing map-based user generated contents for social network service that includes a personal information apparatus, a real-time map engine server and a social network service (SNS) engine server, the sharing system operating method comprising:
receiving global positioning system (GPS) signal through a GPS reception unit of the personal information apparatus;
getting a position information of the personal information apparatus from the GPS signal received in the GPS reception unit;
editing map-based user generated contents by using the position information and a style editing unit;
transmitting the map-based user generated contents to a real-time map engine server by using identification information of the personal information apparatus and the position information;
transmitting the map-based user generated contents including the position information to the personal information apparatus of a other party through the identification information by using the real-time map engine server; and
receiving the map-based user generated contents from the real-time map engine server by using the personal information apparatus.

16. The sharing system operating method of claim 15, wherein the user generated contents include the map-based position information having any one of text, graffiti, memo, file, voice, image, photo, picture, sketch, music or video.
